(19) United States
(12) Patent Application Publication
(10) Pub. No.: US 2012/0106967 A1
(43) Pub. Date: May 3, 2012

(54) METHOD AND DEVICE FOR SIGNAL PROCESSING AND COMMUNICATION SYSTEM COMPRISING SUCH DEVICE

(75) Inventors: Harald Rohde, Muenchen (DE); Ernst-Dieter Schmidt, Feldkirchen-Westerham (DE)

(73) Assignee: NOKIA SIEMENS NETWORKS OY, Espoo (FI)

(21) Appl. No.: 13/121,843

(22) PCT Filed: Sep. 30, 2008
(86) PCT No.: PCT/EP2008/063054

§ 371 Date: May 31, 2011

(51) Int. Cl. H04B 10/02; H04J 14/02; H04B 10/18; H04B 10/06; H04B 10/04

(52) U.S. Cl. 398/79; 398/208; 398/115; 398/136; 398/185; 398/158; 398/141

(57) ABSTRACT

A method and a device provide signal processing. The method contains the steps of separating a pilot signal from an analog signal, reducing or compensating a noise based on a local oscillator laser by demodulating the pilot signal, processing the demodulated pilot signal, and combining the processed demodulated pilot signal with the analog signal. Furthermore, a method for signal processing at a transmitter, according devices and a communication system are described.

The invention relates to a method and to a device for signal processing and communication system comprising such device.

In fiber-optic communications, wavelength-division multiplexing (WDM) is a technology which multiplexes multiple optical carrier signals on a single optical fiber by using different wavelengths (colors) of laser light to carry different signals. This allows for a multiplication in capacity, in addition to enabling bidirectional communications over one strand of fiber.

WDM systems are divided in different wavelength patterns, conventional or coarse and dense WDM. Coarse WDM systems provide, e.g., up to 16 channels in the 3rd transmission window (C-band) of silica fibers around 1550 nm. Dense WDM uses the same transmission window but with denser channel spacing. Channel plans vary, but a typical system may use 40 channels at 100 GHz spacing or 80 channels with 50 GHz spacing. Some technologies are capable of 25 GHz spacing. Amplification options (Raman amplification) enable the extension of the usable wavelengths to the L-band, more or less doubling these numbers.

Optical access networks, e.g., a coherent Ultra-Dense Wavelength Division Multiplex (UDWDM) network, are deemed to be the future data access technology.

At the same time, convergence of wireless as well as wire line networks is an emerging issue to be covered. Hence, transmitting analogue radio over optical fibers may become an advantageous feature to be provided, e.g., connecting the radio transmitter part of mobile wireless base station for multiple-input-multiple-output (MIMO) applications.

However, the UDWDM network is designed for conveying digital data, whereas transmission of analogue signals is not possible due to a phase noise and an amplitude noise provided by a local oscillator laser, which is a mandatory component in the optical network.

The problem to be solved is to overcome the disadvantages set forth above and in particular to provide an efficient approach to process, e.g., transmit and/or receive, analogue signals via a UDWDM network that may be based on coherent optical transmission.

This problem is solved according to the features of the independent claims. Further embodiments result from the depending claims.

In order to overcome this problem, a method for signal processing is provided comprising the steps:
separating a pilot signal from an analogue signal;
reducing or compensating a noise based on a local oscillator laser by
   demodulating the pilot signal;
   processing the demodulated pilot signal;
   combining the processed demodulated pilot signal with said analogue signal.

The pilot signal can be separated from the analogue signal by means of a filter. This approach may be run on an optical receiver component which comprises an local oscillator (LO) laser used for demodulation purposes. The LO signal of such laser may be applied to the incoming signal prior to separating the pilot from the analogue signal.

This approach allows for an at least partial compensation of a phase noise and an amplitude noise of a LO laser that has been used at a transmitter for conveying the signal to the actual receiver. This solution can further be efficiently utilized to compensate the differences between the sender's LO laser and the LO laser at the receiving component.

Hence, the approach described may be run on an optical component that is at least partially associated, deployed or implemented at/with a receiver.

In an embodiment, said signal processing comprises:
demodulating the pilot signal by an IQ demodulator determining a phase and an amplitude of the pilot signal;
inverting and/or scaling the phase and/or the amplitude of the pilot signal;
combining the inverted and/or scaled phase and amplitude with the analogue signal.

IQ demodulator refers to any demodulation generating a phase signal and an amplitude signal.

In another embodiment, said IQ demodulator is driven at a given frequency, which frequency is also used at a sender for modulation purposes.

In a further embodiment, the processed demodulated pilot signal is combined with the analogue signal via a modulator, in particular via an IQ modulator.

Such IQ modulator may be any modulator combining phase and/or amplitude signals (e.g., QPSK, QAM, etc.).

In a next embodiment, the processed demodulated pilot signal combined with said analogue signal is transmitted via a radio interface in particular for MIMO processing purposes.

It may in particular be transmitted via an antenna, wherein several signals at several locations or receivers may be conveyed via several antennas to allow for a combined MIMO processing at a radio receiver.

This approach effectively utilizes the fast optical network to convey information and/or data of any kind to a wireless transmitter without significantly deteriorating the analogue signal to be processed at this wireless transmitter.

It is also an embodiment that the pilot signal comprises an amplitude and phase information of a local oscillator laser, said laser being associated with and/or located at a sender or transmitter.

Thus, any deviance between the LO laser at the sender and the LO at the receiver can at least be compensated partially.

The problem described above is also solved by a method for signal processing at a sender, in particular a or being associated with an optical sender, comprising the steps:
a pilot tone is added to an analogue signal, wherein a frequency of said pilot tone is substantially outside a frequency band of the analogue signal;
an output signal is generated comprising a modulation of the pilot tone and the analogue signal with a local oscillator signal provided by a local oscillator laser.

Pursuant to another embodiment, said output signal is sent via an optical line in particular to the receiver as described herein.

According to an embodiment, said output signal is conveyed towards a device operable as a receiver as described herein.

According to another embodiment, the receiver as described is arranged to receiving and processing this output signal.

In yet another embodiment, said signal to be processed is an wavelength division multiplexing signal, in particular a dense or an ultra dense wavelength division multiplexing signal.

The problem stated above is also solved by a device comprising a and/or being associated with a processor unit and/or a hard-wired circuit and/or a logic device that is arranged such that the method as described herein is executable on said processor unit.

According to an embodiment, the device is a communication device, in particular a or being associated with an optical receiver.

According to another embodiment, the device is a communication device, in particular a or being associated with an optical sender.

The problem stated supra is further solved by a communication system comprising the device as described herein.

Embodiments of the invention are shown and illustrated in the following figures:

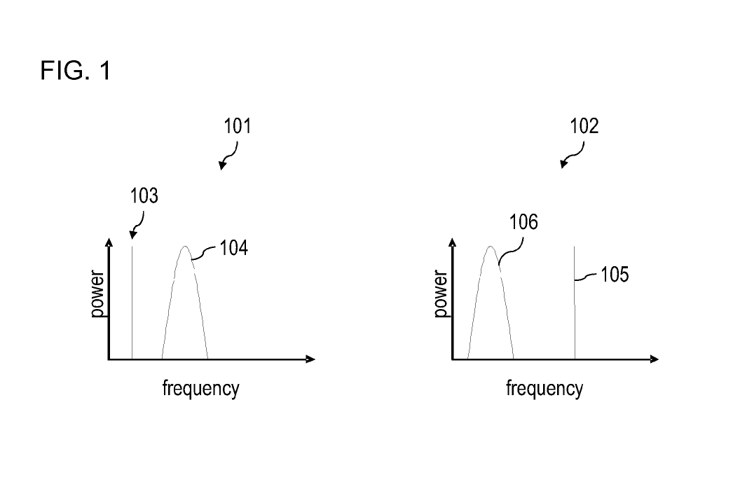

FIG. 1 shows a diagram depicting a pilot tone below a frequency range of an analogue signal and a diagram depicting a pilot tone above a spectrum of an analogue signal;

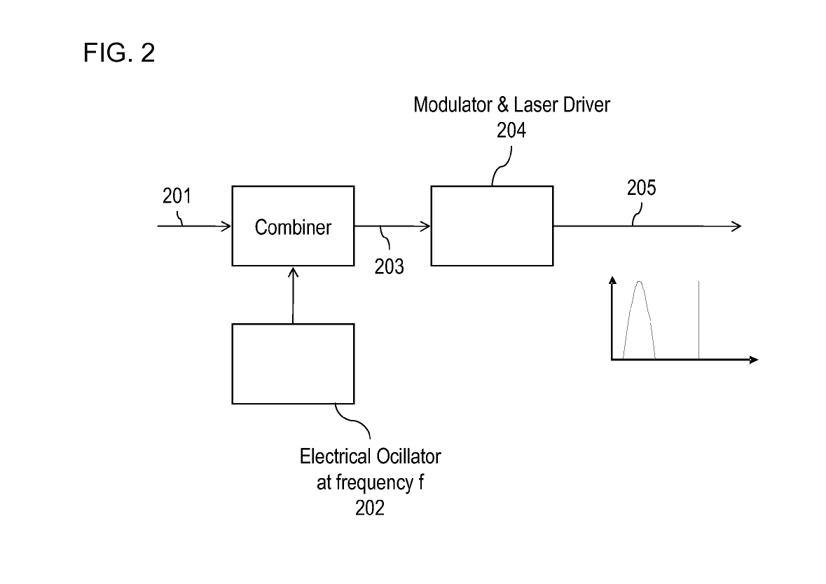

FIG. 2 shows a block diagram of a transmitter combining an analogue signal with a signal from an electrical oscillator, wherein the combined signal is further modulated and conveyed via a laser driver over an optical line;

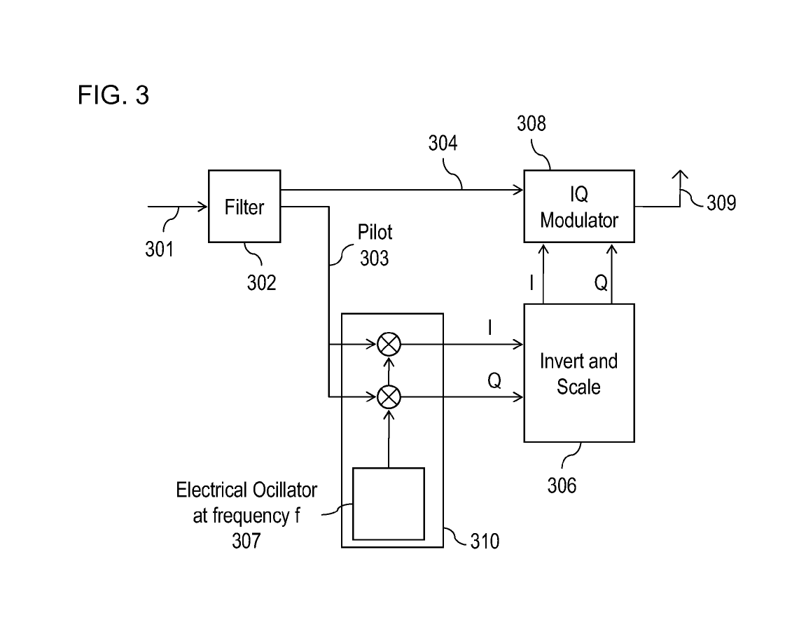

FIG. 3 shows a block diagram of a portion of a receiver, in particular of an optical receiver, that is exemplary combined with a radio transmitter;

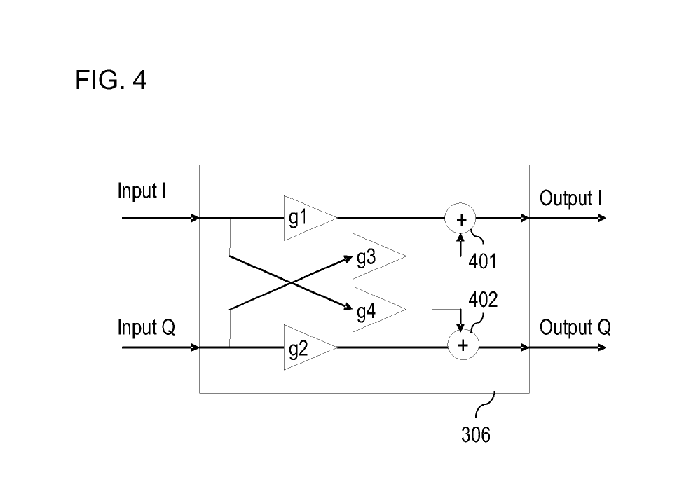

FIG. 4 shows the block 306 of FIG. 3 in more detail, said block 306 comprising an invert and scale functionality providing an I output signal and a Q output signal.

Due to the local oscillator (LO) laser of the optical component, analogue transmission and subsequent coherent detection is within a band of phase noise of this laser.

The signal to be transmitted by a sender is processed, in particular convoluted with a LO signal supplied by the sender's LO laser. In digital data processing, an associated de-convolution (to be processed at the receiver) is also done digitally. Such digital de-convolution, however, is not deemed suitable, e.g., for MIMO processing of analogue signals. In order to allows suitable MIMO processing, the analogue signal supplied to an optical sender has to be conveyed to an optical receiver without substantial deterioration, in particular without adding significant phase noise. Otherwise MIMO processing, e.g., supplying the analogue signal via several antennas towards wireless receivers, won't allow the required results at such receivers.

Hence, this approach suggests adding a pilot tone to an original analogue signal that is to be transmitted. Said pilot tone is preferably set outside a frequency band of the analogue signal to be conveyed.

As the pilot tone itself approximately corresponds to a delta-function peak in the frequency domain, a convolution of this pilot tone with the LO signal results in a signal that exactly contains the particular phase as well as amplitude noise of the local oscillator. Hence, the phase noise of the laser in the transmitter is “frozen” and conveyed to a receiver of the optical network.

The information conveyed to the receiver can thus be used to de-convolute the analogue signal received. The received signal is down-mixed by a local oscillator and further by an electrical oscillator to a baseband range. Information regarding the phase noise of the laser (phase as well as amplitude) can be inverted, scaled and added to the received original analogue signal that arrived at the transmitter.

FIG. 1 shows a diagram 101 depicting a pilot tone 103 below a frequency range of an analogue signal 104 and a diagram 102 depicting a pilot tone 105 above a spectrum of an analogue signal 106.

FIG. 2 shows a block diagram of a transmitter combining an analogue signal 201 with a signal from an electrical oscillator 202, wherein said oscillator 202 provides a particular frequency f. The combined signal 203 is in a block 204 further modulated and conveyed via a laser driver over an optical line 205.

FIG. 3 shows a block diagram of a portion of a receiver, in particular of an optical receiver, that is exemplary combined with a radio transmitter.

A signal 301 is obtained from a coherent receiver (not shown) and fed to a filter 302. The filter 302 provides an analogue signal 304 to an IQ modulator 308. The filter 302 also supplies a pilot 303 that is conveyed to an IQ demodulator 310 operating at a frequency f provided by an electrical oscillator 307. The IQ demodulator conveys an amplitude as well as a phase signal to a block 306 comprising an invert and scale functionality providing an I output signal and a Q output signal, which are further fed to the IQ modulator 308. The output of the IQ modulator is connected to an antenna 309 to be transmitted via a radio interface.

The block 306 is shown in more detail in FIG. 4. The I input signal is fed via an amplifier g1 to an adder 401 and via an amplifier g4 to an adder 402. The Q input signal is fed via an amplifier g2 to the adder 402 and via an amplifier g3 to the adder 401. The output of said adder 401 corresponds to the I output signal and the output of said adder 402 corresponds to the Q output signal of the block 306.

Thus, the I output signal and the Q output signal are individually weighted I- and Q input signals. Each amplifier g1 to g4 may provide a particular gain value that is set according to transfer functions of the whole system. The gain values can be positive or negative (thereby providing an inverting function).

An absolute gain value may be smaller than one (thus this amplifier behaves as an attenuator) and it can be larger than one (thus, providing an actual amplification).

The pilot 303 corresponds to the pilot signal added at the transmitter and by being processed in said block 306 allows for a compensation of a phase noise between the LO laser at the receiver and the LO laser at the transmitter. The output of said block 306 thus substantially corresponds to the analogue signal with no significant deviation or deterioration from the original analogue signal that may be based on LO differences (between receiver and transmitter). Thus, this approach can be efficiently used for, e.g., MIMO processing by providing analogue output signals via said antenna 309 (or providing various analogue signals via several antennas at several receivers).

1-15. (canceled)

16. A method for signal processing, which comprises the steps of:
separating a pilot signal from an analog signal;
performing one of reducing or compensating a noise based on a local oscillator laser by demodulating the pilot signal resulting in a demodulated pilot signal;
processing the demodulated pilot signal resulting in a processed demodulated pilot signal; and
combining the processed demodulated pilot signal with the analog signal.

17. The method according to claim 16, which further comprises:
demodulating the pilot signal by an IQ demodulator determining a phase and an amplitude of the pilot signal;
inverting and/or scaling the phase and/or the amplitude of the pilot signal; and
combining the inverted and/or scaled phase and amplitude with the analog signal.

18. The method according to claim 17, which further comprises:
driving the IQ demodulator at a given frequency; and
using the given frequency at a sender for modulation purposes.

19. The method according to claim 16, which further comprises combining the processed demodulated pilot signal with the analog signal via a modulator.

20. The method according to claim 16, which further comprises transmitting the processed demodulated pilot signal combined with the analog signal via a radio interface for MIMO processing purposes.

21. The method according to claim 16, wherein the pilot signal contains an amplitude and phase information of the local oscillator laser, the local oscillator laser being associated with and/or located at a transmitter.

22. The method according to claim 16, which further comprises combining the processed demodulated pilot signal with the analog signal via an IQ modulator.

23. A method for signal processing in a sender, which comprises the steps of:
adding a pilot tone to an analog signal, wherein a frequency of the pilot tone is substantially outside a frequency band of the analog signal; and
generating an output signal having a modulation of the pilot tone and the analog signal with a local oscillator signal provided by a local oscillator laser.

24. The method according to claim 23, which further comprises sending the output signal via an optical line.

25. The method according to claim 23, wherein said output signal is conveyed towards a device operable programmed to:
separate a pilot signal from the analog signal;
perform one of reducing or compensating a noise based on the local oscillator laser by demodulating the pilot signal resulting in a demodulated pilot signal;
process the demodulated pilot signal resulting in a processed demodulated pilot signal; and
combine the processed demodulated pilot signal with the analog signal.

26. The method according to claim 23, which further comprises receiving and processing the output signal via an optical line.

27. The method according to claim 23, wherein the output signal to be processed is a wavelength division multiplexing signal.

28. The method according to claim 23, wherein the output signal to be processed is selected from the group consisting of a dense wavelength division multiplexing signal and an ultra dense wavelength division multiplexing signal.

29. A device, comprising:
at least one apparatus selected from the group consisting of a processor unit, a hard-wired circuit and a logic device, said at least one apparatus programmed to:
separate a pilot signal from an analog signal;
perform one of reducing or compensating a noise based on a local oscillator laser by demodulating the pilot signal resulting in a demodulated pilot signal;
process the demodulated pilot signal resulting in a processed demodulated pilot signal; and
combine the processed demodulated pilot signal with the analog signal.

30. The device according to claim 29, wherein the device is a communication device.

31. The device according to claim 30, wherein said communication device is an optical receiver.

32. The device according to claim 30, wherein said communication device is configured to be associated with an optical receiver.

33. The device according to claim 30, wherein said communication device is an optical sender.

34. The device according to claim 30, wherein said communication device is configured to be associated with an optical sender.

35. A communication system, comprising:
at least one apparatus selected from the group consisting of a processor unit, a hard-wired circuit and a logic device, said at least one apparatus programmed to:
separate a pilot signal from an analog signal;
perform one of reducing or compensating a noise based on a local oscillator laser by demodulating the pilot signal resulting in a demodulated pilot signal;
process the demodulated pilot signal resulting in a processed demodulated pilot signal; and
combine the processed demodulated pilot signal with the analog signal.

36. A device, comprising:
at least one apparatus selected from the group consisting of a processor unit, a hard-wired circuit and a logic device, said at least one apparatus programmed to:
add a pilot tone to an analog signal, wherein a frequency of the pilot tone is substantially outside a frequency band of the analog signal; and
generate an output signal having a modulation of the pilot tone and the analog signal with a local oscillator signal provided by a local oscillator laser.
